(19) United States
(12) Patent Application Publication
(10) Pub. No.: US 2008/0178142 A1
(43) Pub. Date: Jul. 24, 2008

(54) Hotspot detection method for design and validation of layout for semiconductor device

(75) Inventor: Yorio Takada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY, INC., Tokyo (JP)

(21) Appl. No.: 11/907,578

(22) Filed: Oct. 15, 2007

(30) Foreign Application Priority Data
Oct. 16, 2006 (JP) 2006-281745

(51) Int. Cl. G06F 17/50

(52) U.S. Cl. 716/20

(57) ABSTRACT

A hotspot detection method for detecting a hotspot in a layout for a semiconductor device, includes: dividing a target analysis area into a grid based on layout data about the semiconductor device; and determining whether the grid falls into a hotspot or not, based on the results from simulation, using at least a detection criterion concerning a direction perpendicular to a direction of film thickness.

This application is based upon and claims the benefit of priority from Japanese patent application No. 2006-281745, filed on Oct. 16, 2006, the disclosure of which is incorporated herein in its entirety by reference.

### BACKGROUND OF THE INVENTION

1. Field of the Invention

The present invention relates to technologies for arranging a layout for a circuit element or wiring in a semiconductor device, and particularly to a method and apparatus for detecting or locating a hotspot upon design and validation of a layout, and a method of designing a semiconductor device using such hotspot detection method.

2. Description of the Related Arts

As a design rule used in fabrication of semiconductor devices has become finer, layout design of a semiconductor device and validation of the layout designed are becoming important. In the layout design, in the view of a wiring length or degree of integration, it is required for the design to be most suitable. In the validation of the layout, the layout designed is studied on practical operability in view of processes used for fabricating a semiconductor device, and further factors for lowering yield in fabrication. To support such design and validation of a layout, software tools such as various DFM (Design for Manufacturing)/DFY (Design for Yield) tools have been developed. In fabrication of a semiconductor device, after a phase of design and validation of a layout is repeated, a mask pattern actually used in fabricating processes is created.

By the way, a defect caused in a semiconductor device often occurs at a portion where a wiring pattern or an insulating film is not patterned just as intended shapes in a manufactured semiconductor device due to restrictions or the like in semiconductor fabricating processes. Such portion is called “hotspot.” The hotspot may include, for example, a portion where resolution may be often insufficient in exposure due to considerable unevenness on a surface of a semiconductor substrate, a portion where poor etching may be often applied due to pattern dependency in etching, a portion where a surface may be insufficiently flattened by CMP (Chemical Mechanical Polishing) due to an effect caused from an underlying wiring pattern, or a portion where breaking of wire or short-circuit is likely to occur because of excessively high wiring density.

To improve yield of a semiconductor device in the fabrication, it is necessary to give extra consideration from a phase of layout design not so as to generate a hotspot, with considering a process margin. For this purpose, in layout design of a semiconductor device, it is necessary to repeat procedures in which, after the layout design is implemented based on a circuit diagram to create mask data, validation whether a hotspot is present in the layout or not is performed using the software tools described above, and if a hotspot is found, the layout is redesigned.

FIG. 1 shows one example of processes of a related art for detecting or locating a hotspot in a designed layout. First, at box 101, a target device is selected and mask data to be validated is read in. The mask data is data about a layout designed for a target semiconductor device. Next, at box 102, to detect a hotspot, processing for extracting a graphic pattern from the mask data is conducted. In the processing for extracting the graphic pattern, first, a grid size is set, that is, an analysis mesh is defined for setting a condition for extracting the graphic pattern, and next, an analysis area is set, and an analysis layer is specified. Then, the analysis mesh is set in the mask data of the specified analysis layer in a range of the set analysis area, and the graphic pattern, that is, each mesh is extracted. In the following description, the detection of a hotspot includes detecting the existence of a hotspot and locating the position of the hotspot.

As for criteria for detecting a hotspot, there are graphic pattern density, i.e., a rate of rough portions and thick portions in a layout pattern based on which a hotspot is detected, and a residual step based on which a hotspot is detected, and one of the two criteria is selected. The residual step is a size of a step or terraced portion still remaining on a surface of a device even after flattened by CMP or the like.

Then, at box 103 following box 102, it is determined whether a hotspot is to be detected or not in compliance with the obtained graphic pattern density, and when a hotspot detection based on the graphic pattern density is selected, two-dimensional density analysis is carried out. In the two-dimensional density analysis, as shown in FIG. 2A, pattern density is obtained for each grid, which is a minimum unit for analysis, in the set analysis area and the set analysis layer, and the pattern density is compared with an average density of the entire device. Then, a grid or an area is detected where the pattern density is lower or higher than the average density of the entire device.

When a hotspot detection based on the graphic pattern density has not been carried out, an analysis algorithm is selected and conditions for various processes are set in order to prepare to detect a hotspot based on the residual step, and a residual step is predicted by simulation, at box 104. As for the conditions for the processes, there may be, for example, an amount of deposition or a polishing time. Then, at box 105, the results of the prediction are outputted, and a film thickness or the residual step is checked based on the results obtained from the simulation. Next, at box 106, it is determined whether a hotspot is to be detected or not in compliance with the residual step, and when a hotspot is to be detected based on the residual step, two-dimensional step analysis for obtaining the film thickness is carried out.

In the two-dimensional step analysis, as shown in FIG. 2B, layers of the same material adjacent to each other in a grid are compared in film thickness, and an area whose film thickness is larger or smaller than an average film thickness of the entire device is detected. Alternatively, as shown in FIG. 2C, an area where |A−B|>C or |A−C|<C is detected, where A and B are respectively thicknesses of films made of different material from each other (i.e., material A and material B), and C is a boundary condition. In FIG. 2C, an area of the material B is hatched.

In a related art of the present invention, a hotspot is detected as described above. In addition, as for a document generally disclosing a simulation method, there are Japanese Patent Laid-Open No. 2002-110809 (JP 2002-110809A) and Japanese Patent Laid-Open No. 2002-140655 (JP 2002-140655A).

In the hotspot detection method as described above, criteria for detecting a hotspot are defined only for a vertical component, that is, the density and the film thickness. The vertical component is a component in the direction of film thickness. No criterion for detecting a hotspot is defined for a lateral component, that is, a distance. The term “distance” used herein is a distance in a device in the direction perpendicular to the direction of film thickness. Since the criteria concerning the lateral component are not defined in the method described above, a hotspot is detected simply based on only the definition of the vertical component, regardless of an impact on a process margin, and therefore it is not necessarily able to suitably detect a hotspot.

A CMP process of an oxide film will be described as an example that suitable detection of hotspot cannot be provided, with respect to a situation that detection of hotspot is carried out as shown in FIG. 2B. In addition, for example, Japanese Patent Laid-Open No. 2002-342399 (JP 2002-342399A) and Japanese Patent Laid-Open No. 2005-79207 (JP 2005-079207A) disclose that, in the CMP process of an oxide film, unevenness is formed on a surface due to an underlying wiring pattern after polishing.

FIG. 3 shows one example of the results from measurement of flatness on a polished surface of a device after the CMP process of an oxide film. The results were obtained by an AFM (Atomic Force Microscope). The residual steps at point A and point B in FIG. 3 each are about 13 nm and in a comparable level. However, a shape at point A is concave with a high aspect ratio and a shape at point B is gently concave, so that there is a difference therebetween.

Assuming that, as shown in FIG. 4, after a surface of an oxide film is flattened by the CMP process, a hole for a plug is formed into the oxide film by a lithography process and a dry etching process, and subsequently a metal film of tungsten is deposited, finally the plug is separated and formed by a W-CMP (tungsten CMP) process. At this time, a defect caused by the W-CMP process is likely to occur only at point A in form of a tungsten (W) residue and not to occur at point B. This difference is caused by difference of the aspect ratios of the residual steps between point A and at point B. In the example shown in FIG. 4, the aspect ratio of the residual step at point A is 2.4, and the aspect ratio of the residual step at point B is 0.47, and therefore the aspect ratio of the residual step at point A is about five times larger than that at point B as compared. Because the aspect ratios of the residual steps are different although heights of the residual steps are in a comparable level as described above, a defect will occur or not. This suggests that concerning a hotspot, the definition of the criteria for the lateral component, namely, the distance is very important, and further the definition used in the hotspot detection method described above may be thought insufficient.

In the hotspot detection method described above, because a hotspot is detected or located using only the definition of the vertical component, that is, the density or the film thickness, there arises a problem that hotspot detection in conformity with a process margin cannot be provided. As the result, modification of a design or a layout for a semiconductor device is not suitably made, and therefore the modification does not directly lead to suitable enlargement of the process margin and improvement in yield in fabrication processes.

### SUMMARY OF THE INVENTION

An object of the present invention is to provide a hotspot detection method that can suitably enlarge a process margin and directly apply the results from the hotspot detection to improve yield in the fabrication processes.

Another object of the present invention is to provide a design method for a semiconductor device using such hotspot detection method.

According to a first aspect of the present invention, a hotspot detection method for detecting a hotspot in a layout for a semiconductor device includes: dividing a target analysis area into a grid based on layout data about the semiconductor device; and determining whether the grid falls into a hotspot or not, based on the results from simulation, using at least a detection criterion concerning a direction perpendicular to a direction of film thickness.

According to a second aspect of the present invention, a hotspot detection method includes: detecting the hotspot using, in addition to a first detection criterion concerning a direction of film thickness, a second detection criterion concerning a direction perpendicular to the direction of film thickness.

According to a third aspect of the present invention, a design method for a semiconductor device includes determining a layout for a semiconductor device by applying the hotspot detection method described above.

In the present invention, by additionally using, as a condition for detection of hotspot, a lateral component, that is, a criterion of a component of distance in a semiconductor device in the direction perpendicular to the direction of film thickness in the semiconductor device, a difference in density or a difference in an aspect ratio of a residual step obtained from simulation can be used for detection of hotspot, thereby hotspot detection in conformity with a process margin can be implemented. As the result, in a design phase of a semiconductor device, design can be early modified to have consideration to a process margin, which largely contributes to improvement in yield in a fabrication phase. Further, by incorporating the method of the present invention, an accurate DFM/DFY tool can be provided.

The above and other objects, features, and advantages of the present invention will become apparent from the following description based on the accompanying drawings which illustrate examples of preferred exemplary embodiments of the present invention.

### BRIEF DESCRIPTION OF THE DRAWINGS

FIG. 1 is a flow chart illustrating processes for a hotspot detection method of a related art;

FIGS. 2A to 2C are views for describing a criterion for detection of hotspot;

FIG. 3 is a graph illustrating one example of the results from measurement of flatness on a surface of a device after application of a CMP process of an oxide film;

FIG. 4 is a schematic diagram for describing defect occurrence caused by a residual step; and

FIG. 5 is a flow chart illustrating processes for a hotspot detection method of one exemplary embodiment of the present invention.

### DETAILED DESCRIPTION OF EXEMPLARY EMBODIMENTS OF THE INVENTION

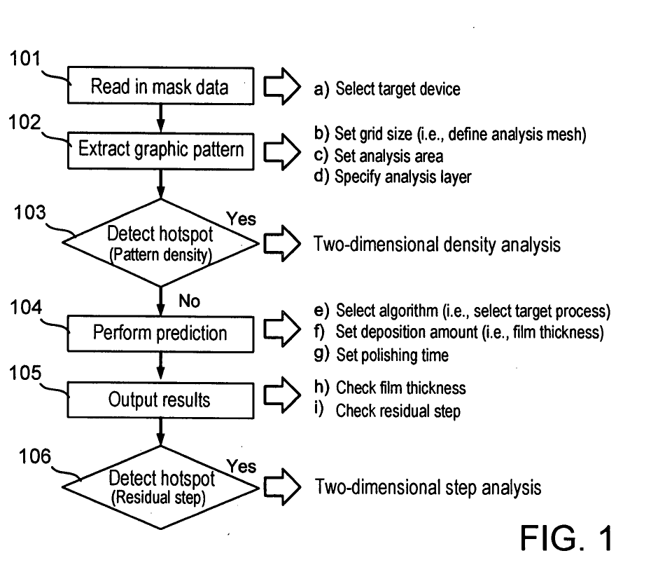

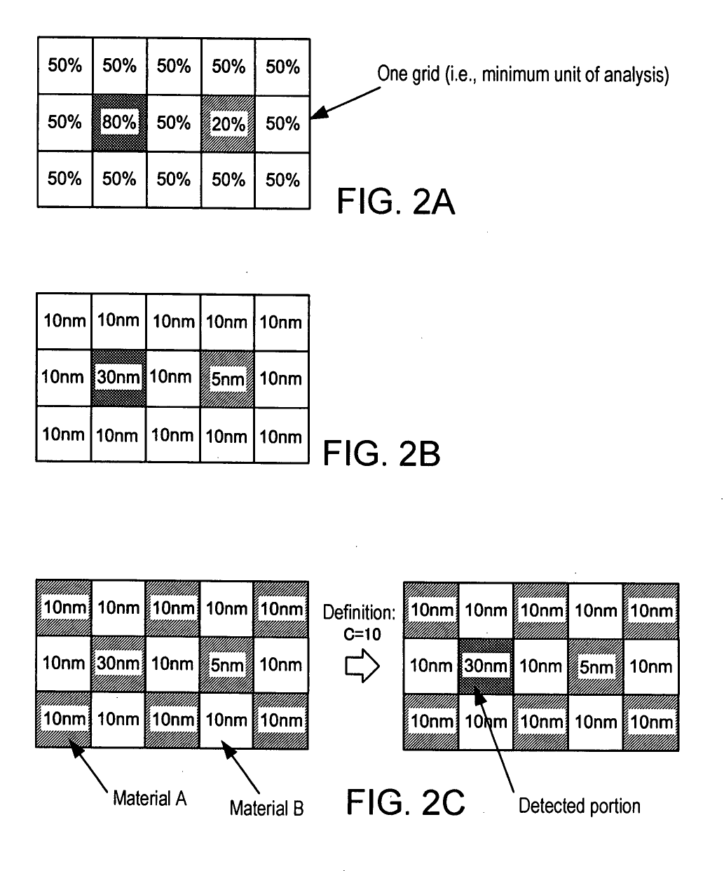

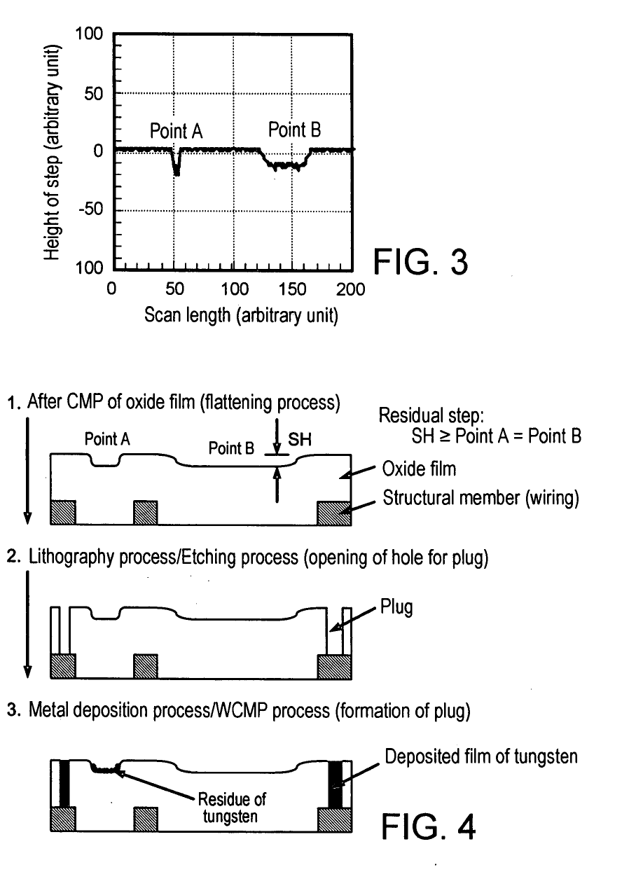

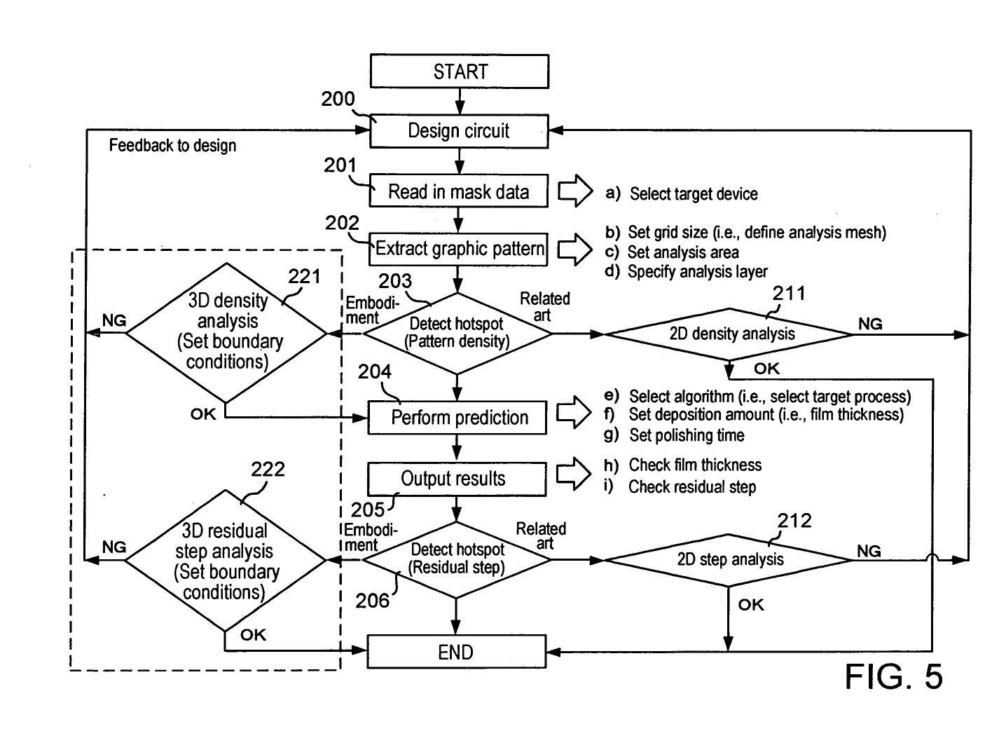

Processes for a hotspot detection method of one exemplary embodiment of the present invention shown in FIG. 5, compared to the processes shown in FIG. 1, further includes a process carried out by using a process criterion in the lateral direction. In FIG. 5, the processes using the detection criterion of the vertical component similar to FIG. 1 are designated by “Related Art” at boxes 203, 206. Whereas, the processes using a detection criterion in the lateral direction, which provide a feature of this exemplary embodiment, are designated by “Embodiment” at boxes 203, 206. Here, there is shown an example that detection of hotspot is performed for a CMP process of an oxide film and a semiconductor device is designed using the results of the hotspot detection. Now, the processes of the present exemplary embodiment will be hereinafter described in detail.

At box 200, a semiconductor device is designed in circuitry, and as the result, mask data is created. Next, at box 201, a target device is selected and mask data to be validated is read in. Next, at box 202, the mask data is processed to extract a graphic pattern for detection of hotspot. The process for extracting a graphic pattern at box 202, similarly to the process for extracting a graphic pattern at box 102 in FIG. 1, sets a grid size and an analysis area and specifies an analysis layer in this order, and sets an analysis mesh to extracting a graphic pattern, that is, each mesh.

Next, at box 203, it is determined whether hotspot detection is carried out in compliance with graphic density based on the extraction results or not, and when hotspot detection is performed in compliance with the graphic density, it is selected whether two-dimensional (2D) density analysis is performed (“Related Art”) or three-dimensional (3D) density analysis is done (“Embodiment”). When the two-dimensional density analysis is selected, the two-dimensional density analysis similar to one described with reference to FIG. 1 is done, at box 211. As the result of the two-dimensional density analysis, when defect occurrence in the semiconductor device is predicted (“NG”), the process returns to box 200 to redesign the circuitry, and when no defect occurrence is predicted (OK), the process ends.

On the one hand, when the three-dimensional density analysis is selected at box 203, one or more boundary conditions (e.g., Condition 1, Condition 2, . . . ) are set to conduct the three-dimensional density analysis, at box 221. As the result of this three-dimensional density analysis, when defect occurrence in the semiconductor device is predicted (NG), the process returns to box 200 to redesign the circuitry, and when no defect occurrence is predicted (OK), the process proceeds to box 204. Further, when hotspot detection in compliance with the graphic density is not selected at box 204, the process also proceeds to box 204.

At box 204, similarly to box 104 in FIG. 1, to prepare hotspot detection in compliance with the residual step, a step or height of terraced portion is predicted by simulation. Then, at box 205, the results from the simulation are outputted, and the film thickness or the residual step is checked based on the results from the simulation. The process then proceeds to box 206.

At box 206, it is determined whether hotspot detection is conducted in compliance with the residual step or not, and when hotspot detection is performed in compliance with the residual step, it is selected whether the two-dimensional (2D) step analysis is performed (“Related Art”) or the three-dimensional (3D) step analysis is done (“Embodiment”). When the two-dimensional step analysis is selected, the two-dimensional step analysis similar to one described with reference to FIG. 1 is done, at box 212. As the result of the two-dimensional step analysis, when defect occurrence in the semiconductor device is predicted (NG), the process returns to box 200 to redesign the circuitry, and when no defect occurrence is predicted (OK), the process ends.

On the one hand, when the three-dimensional step analysis is selected at box 206, one or more boundary conditions (e.g., Condition 1, Condition 2, . . . ) are set to conduct the three-dimensional step analysis, at box 222. As the result of this three-dimensional step analysis, when defect occurrence in the semiconductor device is predicted (NG), the process returns to box 200 to redesign the circuitry, and when no defect occurrence is predicted (OK), the process ends.

As described above, in the present exemplary embodiment, the density or the aspect ratio of the residual step is set as the criterion for detection of hotspot, and a hotspot is detected or located in compliance with the aspect ratio. In the three-dimensional density analysis and the three-dimensional step analysis, the hotspot detection is carried out based on, for example, following equation (1):

$$\frac{[ D ( MAX ) - D ( MIN ) ]}{Sn} \leq T \qquad ( 1 )$$

where S is a grid size, n is the number of grids, D(MAX) is maximum density (or maximum thickness of film) of an adjacent grid, D(MIN) is minimum density (or minimum thickness of film) of the adjacent grid, and T is a boundary condition.

As described above, in the present exemplary embodiment, by including the criterion based on the lateral component (i.e., distance component) in the hotspot detection method of a related art based on the two-dimensional analysis, hotspot detection in three dimensions can be conducted.

The hotspot detection method of the present exemplary embodiment described above can be also performed by executing each of the processes described above on a computer by software. Therefore, a program for executing the processes described above on a computer and a recording medium for storing such program also fall into the scope of the present invention. Such program executes, on a computer, processes, for example, a process for receiving layout data about a semiconductor device as input data, a process for dividing a target analysis area into a grid based on the layout data of a semiconductor device, a process for obtaining a film thickness and a step for each of divided grids by simulation, a process for determining whether the grid falls into a hotspot or not, based on the results from the simulation, using the detection criterion concerning the direction of film thickness and the detection criterion concerning the direction perpendicular to the direction of film thickness, and a process for outputting the determination results.

As described above, the hotspot detection method of the present invention has been described with respect to the CMP process of an oxide film as an example, but an applicable scope of the present invention is not limited to this. For example, in the present invention, by setting a plurality of hotspot boundary conditions, detection of hotspot can be implemented under desired conditions in conformity with various processes. Further, the method of the present invention can be used, besides for the CMP process, for example, for calculation of DOF (Depth of Focus) in a lithography process and an over etching margin in an etching process. The hotspot detection in compliance with the density can be also used to detect a pattern created by a micro loading effect generated in a CVD (Chemical Vapor Deposition) process or an etching process.

As mentioned above, as the result of application of the present invention, in a design phase of a semiconductor device, design can be early modified to have consideration to a process margin, which can largely contribute to improvement in yield in fabrication processes.

While exemplary embodiments of the present invention have been described using specific terms, such description is for illustrative purposes only, and it is to be understood that changes and variations may be made without departing from the spirit or scope of the following claims.

What is claimed is:

1. A hotspot detection method for detecting a hotspot in a layout for a semiconductor device, comprising:
dividing a target analysis area into a grid based on layout data about the semiconductor device; and
determining whether the grid falls into a hotspot or not, based on the results from simulation, using at least a detection criterion concerning a direction perpendicular to a direction of film thickness.

2. The method according to claim 1, wherein another detection criterion concerning the direction of film thickness used in the determining.

3. The method according to claim 1, further comprising:
obtaining a step for each of divided grids by the simulation; and
obtaining an aspect ratio of the step,
wherein said hotspot is detected in compliance with the aspect ratio.

4. The method according to claim 1, further comprising:
obtaining a graphic density for each of divided grids by the simulation; and
obtaining an ratio of the graphic density between adjacent grids,
wherein said hotspot is detected in compliance with the ratio.

5. A hotspot detection method for detecting a hotspot in a layout for a semiconductor device, comprising:
detecting the hotspot using, in addition to a first detection criterion concerning a direction of film thickness, a second detection criterion concerning a direction perpendicular to the direction of film thickness.

6. The method according to claim 5, further comprising:
setting the first criterion and the second criterion.

7. A design method for a semiconductor device, comprising:
determining a layout for a semiconductor device by applying the hotspot detection method according to claim 1.

8. A design method for a semiconductor device, comprising:
determining a layout for a semiconductor device by applying the hotspot detection method according to claim 5.
